(19) United States
(12) Patent Application Publication
(10) Pub. No.: US 2019/0274278 A1
(43) Pub. Date: Sep. 12, 2019

(54) WIRE FRAME PET PERCH

(71) Applicants: Sarabjit S. Randhava, Evanston, IL (US); PAUL B. SPECHT, Wilmette, IL (US); JAMES N. ELESH, Evanston, IL (US)

(72) Inventors: Sarabjit S. Randhava, Evanston, IL (US); PAUL B. SPECHT, Wilmette, IL (US); JAMES N. ELESH, Evanston, IL (US)

(21) Appl. No.: 15/918,263

(22) Filed: Mar. 12, 2018

(51) Int. Cl. A01K 1/035; F16B 2/22; F16M 13/02; F16B 2/00

(52) U.S. Cl. CPC A01K 1/035; F16B 2/005; F16M 13/022; F16B 2/22

(57) ABSTRACT

A pet perch comprising of a rectangular wire frame and wire wall brace with brace clips that firmly attaches the frame to the wall brace. The assembly can be attached to window sills (single hung and double hung design) using sill clips or to windows without sills (casement design) using sill clips eliminating the necessity for attachment by screws, hook and loop fasteners and suction cups. The assembly can be moved from window to window since the sill clips are easily movable

### FIELD OF THE INVENTION

The current invention relates to a wire frame pet perch with removable and stretchable fabric cover that can be attached to a window sill or window assembly without the use of mechanical or adhesive devices such as screws, hook and loop fastening tapes, suction cups, etc.

### BACKGROUND OF THE INVENTION

Domesticated cats are very curious creatures which typically enjoy spending significant time on window sills staring at the going and comings of the world outside. They also use the sill area for sunbathing and sleeping. Since many window sills tend to be very narrow, however, it is necessary to construct a window perch that sits partially on top of the sill while at the same time extending the area needed to provide additional space upon which the cat can perch.

There are two types of perches currently available. The first kind is constructed of a hard surface area such as particle board, wood or Masonite which is covered with either carpet or fabric placed over a cushioning layer such as polyurethane foam. The second type is a molded plastic frame with a removable cover. Both types are attached to a sill by a variety of methods.

For example, one product currently on the market employs a pair of L-shaped brackets that are mounted to the bottom of the perch, and two series of holes formed at the front end of the perch adjacent to the window and on opposite sides of the perch. The free ends of the L-shaped brackets abut the wall underneath the window sill to provide one means of support, and a second means of support is provided in the form of fasteners, which are inserted through one of the holes in each series and anchored to the window sill. The series of holes are employed to provide alternative locations for the fastening of the perch to the window sill because window sills come in different depths (i.e. the distance from the wall to the end of the window sill).

Another product on the market uses a single U-shaped bracket mounted to the bottom of the perch near its center, and hook and loop fastening means (i.e. Velcro). One of the legs of the U-shaped bracket is longer than the other and its end abuts the wall underneath the window sill to provide one means of support. The hook and loop fastening means comprises three sets of mating pads that are affixed to the window sill and underneath the perch near its leading edge, providing further means of support. Another product uses a pair of adjustable mounting brackets that are secured to the molded plastic frame. The brackets engage channels formed in the underside of the frame and two series of holes extending along the opposite side of the frame. This enables the perch to adapt to various sill sizes. This entire assembly is attached to the window sill using hook and loop fastening means. This fastening methodology is very difficult to peel off without damage to the sill.

All of the above described perches have several problems involved with their designs. They need to have enough window sill area available for the hook and loop fastener or fasteners (usually screws) to be efficaciously attached. Accordingly, these methods of attachment do not satisfy the overall need of a cat perch that can be mounted to a window sill without holes, hook and loop fasteners or other penetrating or adhesion means. Moreover, all of the current perches on the market cannot be used for casement windows which have, by design, no or very little window sill area for attachment.

Accordingly, it is the object of this invention to provide a window perch for attachment to windows with sills (single hung or double hung design) or without sills (casement design), that provide a resting surface for cats that is comfortable and which does not penetrate or adhere to the sill.

It is the further object of this invention to provide a perch having brackets for mounting the perch to the window, with or without a window sill, that do not penetrate or adhere to a sill.

In summary, the prior art devices do not attain the objectives described below.

### SUMMARY

A pet perch for window mounting is provided comprising a wire frame assembly defining an opening larger in width and length than a typical house cat, and a stretchable fabric cover for encasing the wire frame assembly and covering the opening to provide a soft, hammock-like effect. In its preferred embodiment, the frame assembly is generally rectangular and constructed of rigid steel wire, and the stretchable fabric cover is constructed of a soft, lightweight material such as synthetic fleece.

The wire frame assembly comprises of a main frame made of rigid steel wire and a brace made of the same material. The two are connected together using brace clips that can also be moved linearly. This enables the frame assembly to be positioned tightly against the wall.

In its preferred embodiment, the invention includes a means for securing the frame to the window, with or without a sill, by means of a pair of sill clips that are designed to be located at one end between the window jamb and sill (single and double hung design) or window jamb and sill assembly (casement design), while the other end of the clip clamps around the wire assembly which is covered by the stretchable fabric cover, thus locking the cover securely in place. Each of the pair of mounting brackets is formed out of steel flat stock and sized so that they conform to the dimensions of standard single/double hung windows and casement windows.

The present invention and advantages thereof will become more apparent upon consideration of the following detailed description when taken in conjunction with the accompanying drawings.

### BRIEF DESCRIPTION OF THE DRAWINGS

FIG. 1: A perspective view of the pet perch in one embodiment of the invention shown attached to the window sill.

FIG. 2: A perspective view of the pet perch in a preferred embodiment of the invention shown attached to the window sill.

FIG. 3: An embodiment wire frame assembly of the pet perch comprising of the main frame and the wall brace attached to each other using a brace clip.

FIG. 4: A preferred wire frame assembly of the pet perch comprising of the main frame and the wall brace attached to each other using a brace clip.

FIG. 5: Details of the main frame.

FIG. 6: An embodiment of the wall brace.

FIG. 7: A perspective view of the wall brace clip for the above embodiment.

FIG. 8: A preferred embodiment of the wall brace.

FIG. 9: A perspective view of the wall brace clip for the above preferred embodiment.

FIG. 10: Other embodiments for attaching the main frame to braces using designated brace clips.

FIG. 11: An embodiment of a sill clip for attaching the frame to the window sill.

### DETAILED DESCRIPTION OF THE EMBODIMENTS

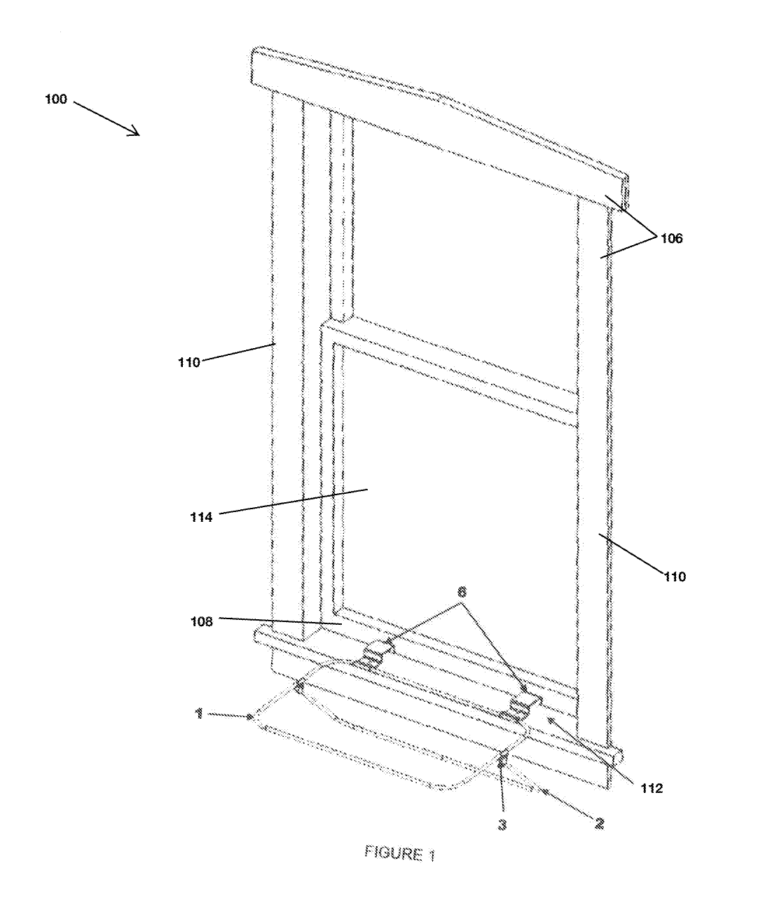

FIG. 1 shows one of the embodiments of the invention where the pet perch is attached to the window sill. In this embodiment, the pet perch comprises of a frame 1 and a wall brace 2 that are connected using a wall brace clip 3. The frame 1 is generally of a rectangular configuration to accommodate the pet lounging characteristics. It can accommodate a stretchable fabric cover made of a soft lightweight material such as synthetic fleece. The frame 1 in its totality is attached to the sill 4 by first adjusting the wall brace 2. This adjustment is made by loosening the screw device on wall brace clip 3 and moving the wall brace 2 laterally until it is snug against the wall. In one preferred embodiment, the screw device comprises of a wing nut and lock washer combination.

In a majority of applications there are windows with sills (single hung or double hung design) or without classical sills (casement design). One of the embodiments as shown in FIG. 1 exhibits a window with sills 5 (single hung or double hung) and its sill 4. In this embodiment, a pair of sill clips 6 (#1 size) are used to attach pet perch, comprising of 1, 2, 3 to the sill 4. In another embodiment, a dimensionally different pair of sill clips 6 (#2 size) is utilized to attach the pet perch to windows 5 that do not possess a sill (casement design).

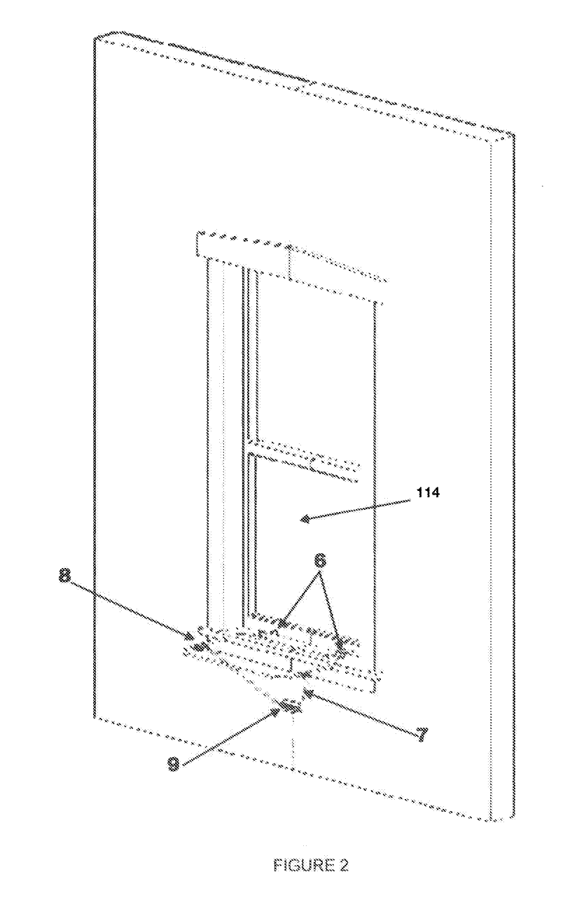

FIG. 2 shows a preferred embodiment of the invention where the pet perch is attached to the window sill. This embodiment employs a different wall brace which has a more triangular configuration. It is understood, this in a structural design, that triangulation results in a higher thrust against a wall. The wall brace is fitted with an extruded pad that inhibits slippage and an even distribution of pressure between the wall brace and the wall. A wall brace clip is used to attach the preferred wall brace 7 to pet perch frame 1.

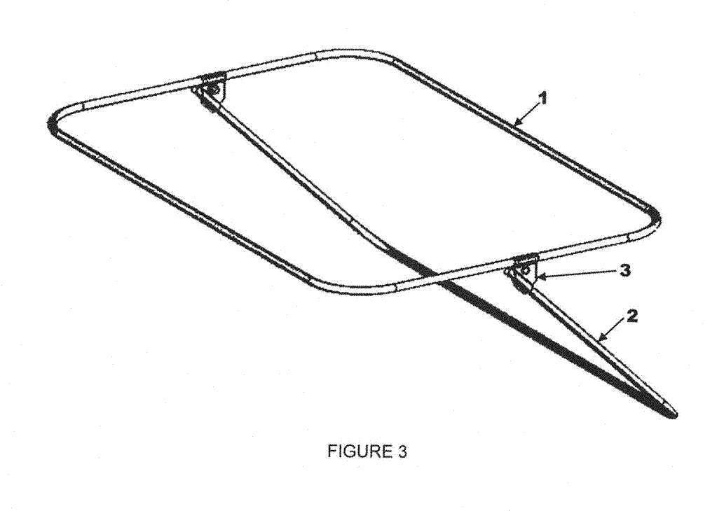

FIG. 3 shows a detailed view of an embodiment of the pet perch. In this embodiment, the frame 1 is attached to the wall brace 2 utilizing a wall brace clip 3. This clip 3 is designed to attach the wall brace 2 at an angle ranging between 10° to 80°. The wall brace clips can be readily adjusted laterally enabling wall brace 2 to be moved to an optimal portion. The wall brace clip 3 uses a wing nut assembly to enable the clip to be easily and readily tightened. A lock washer ensures that the pet perch stays tight after assembly.

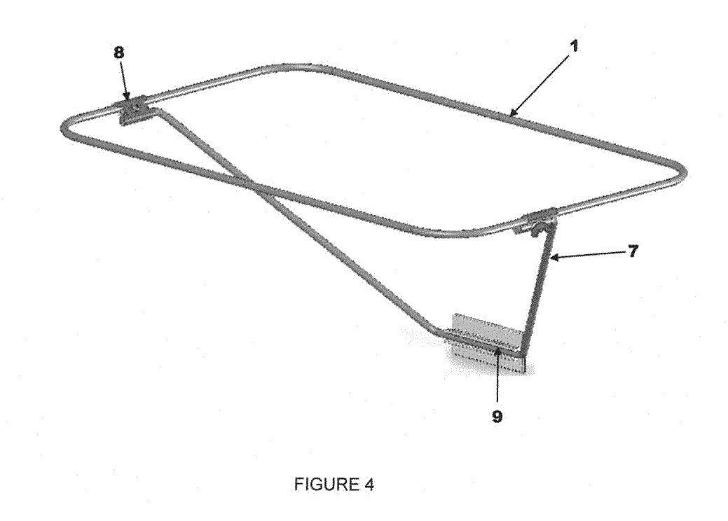

FIG. 4 shows a detailed view of the preferred embodiment of the pet perch. In this embodiment, the wall brace 7 is engineered to have a somewhat triangular configuration that enables a significant amount of thrust against the wall. An extruded pad is incorporated into the wall brace to spread the pressure against the wall. The wall brace is attached to the pet perch wire frame using specially designed brace clips. The wall brace is bent such that it runs parallel to the pet perch frame. This enables a simple brace clip 8 to be designed and incorporated. The brace clip 8 holds the pet perch frame 1 to the wall brace 7 by means of a screw and wing nut assembly. Lock washers may be used appropriately.

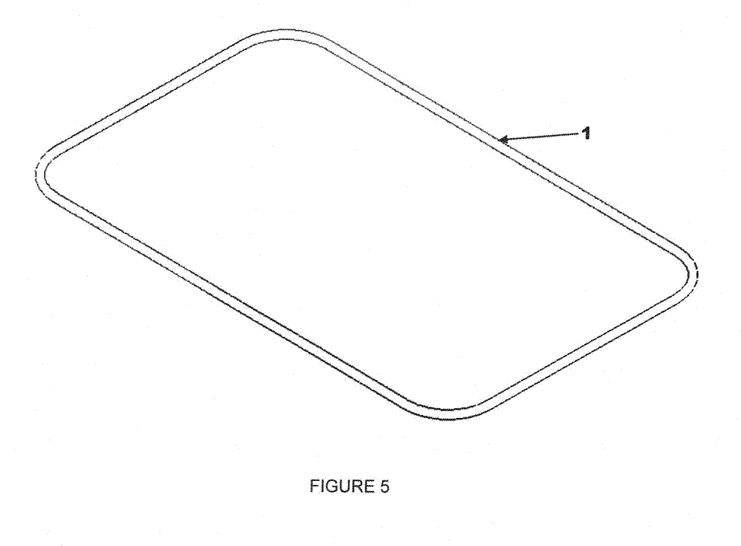

FIG. 5 shows a preferred embodiment of the detail of the main frame 1. In this embodiment, the frame is made of rigid wire ranging in diameter from ⅛″ to 1″ with a preferred size to be 5/16″ in diameter. The main frame is machine bent into a rectangular configuration with softly rounded corners. The roundness of the corners is a designable element which has to take the metal stress and fracture potential into consideration. The formed frame is butt welded immediately and sequentially as soon as it is formed into shape.

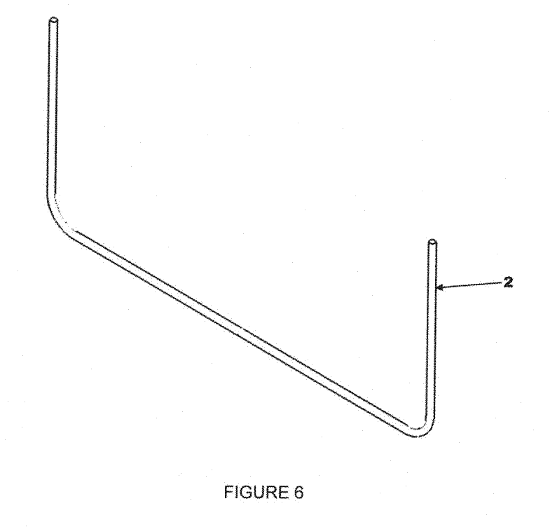

FIG. 6 shows an embodiment of the wall brace 2. In this embodiment, the wall brace is made of rigid wire ranging in diameter from ⅛″ to 1″ with a preferred size to be 5/16″ in diameter. The wire is machine bent into a configuration with softly rounded corners. The roundness of the corners is a designable element which has to take the metal stress and fracture potential into consideration. The formed brace is designed and shaped to ensure that there is no spring back.

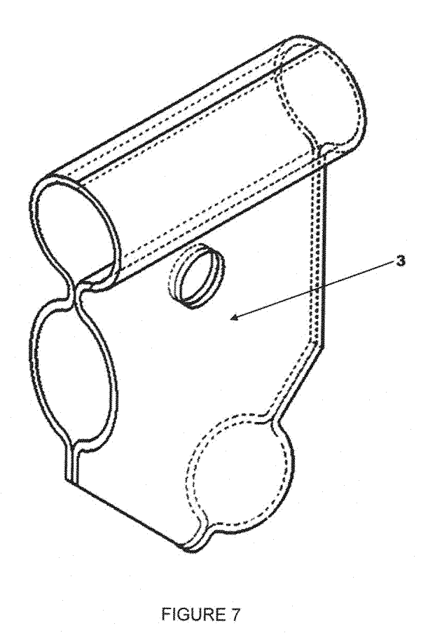

FIG. 7 shows an embodiment of brace clip 3. In this embodiment, the brace clip 3 is made of a flat metal sheet stock that can range in thickness from 16 to 24 gauge. In this embodiment, the thickness is 22 gauge CRS. The brace clip 3 comprises of a die formed assembly that incorporates two circular channels. The upper round channel is designed to be horizontal and accommodates the main frame 1. The lower round channel is at an angle ranging from 10° to 80° and is designed to accommodate the wall brace 2. The preferred angle is in the proximity of 45° to maximize the leverage effect.

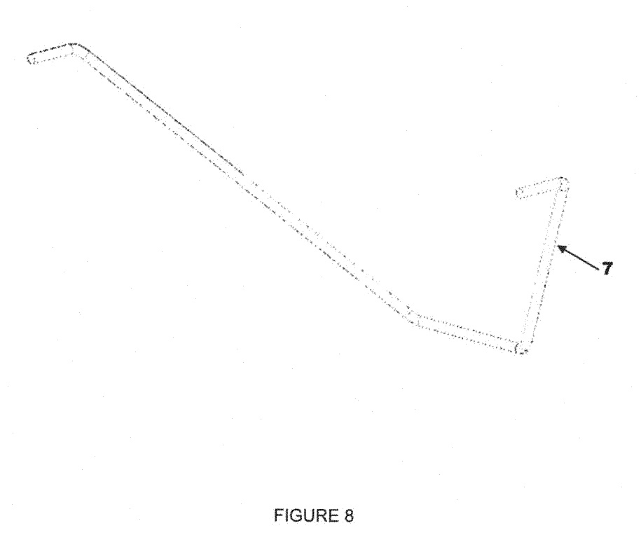

FIG. 8 shows a preferred embodiment of wall brace 7. In this embodiment, the wall brace is made of rigid wire ranging in diameter from ⅛″ to 1″ with a preferred size to be 5/16″ in diameter. The wire is machine bent into a configuration with softly rounded corners. The roundness of the corners is a designable element which has to take the metal stress and fracture potential into consideration. Geometrically the wall brace 7 comprise of wire that starts with two parallel prongs that bend down and tilt inwards at an acute angle in a triangulating manner. The wire is bent at an appropriate place to ensure an appropriate length to face the wall.

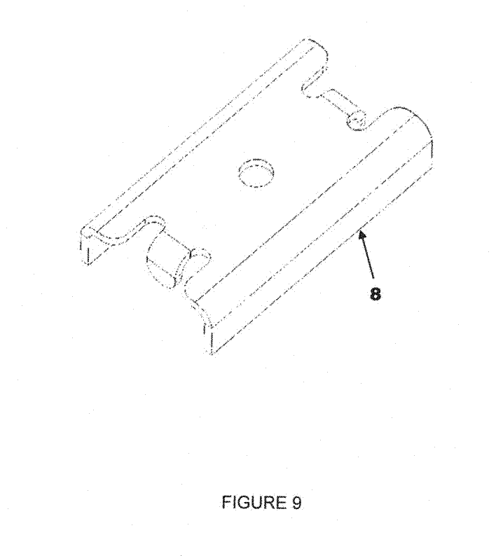

FIG. 9 shows a preferred embodiment of brace clip 8. In this embodiment, the brace clip 8 is made of flat metal sheet stock that can range in thickness from 16 to 24 gauge. In the preferred embodiment, the thickness is 18 gauge CRS. The brace clip 8 comprises of a die formed assembly where the two long edges are rolled over at 90 degree angles. This comprises the longitudinal component of the brace clip 8. Another die form step is conducted to create two tongues along the center axis of the brace clip 8. These tongues are also rolled over at 90 degree angles. A hole to accommodate a number 8 ANSI machine screw is drilled into the center of the brace clip 8. The brace clip thus manufactured will accommodate a 5/16″ wire from the pet perch frame 1 and a 5/16″ wire from the wall brace 7. The tongues of the brace clip ensure a separation of the wires and consequently, enables a number 8 ANSI screw to go through the hole and the gap created between the two wires. The number 8 ANSI screw may have lock washers and an appropriate wing nut assembly.

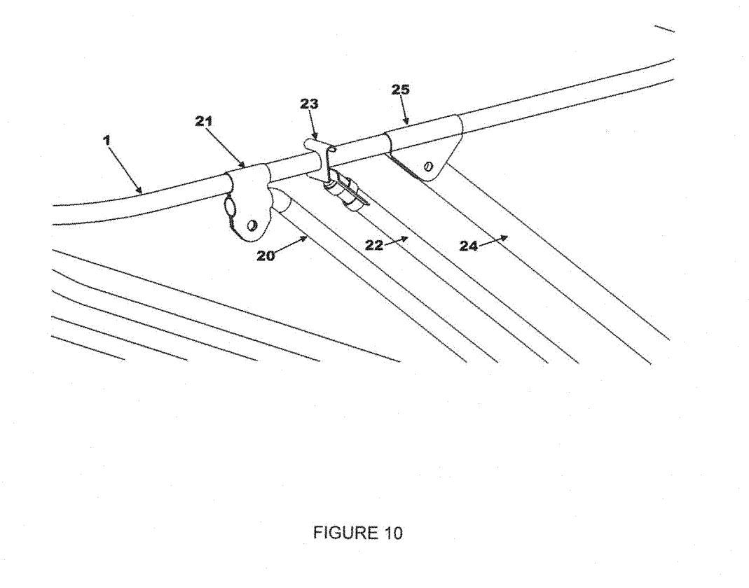

FIG. 10 shows other embodiments that can be used to secure the main frame. One of the embodiments shows a wall brace 20 that hooks parallel to the main frame 1. This wall brace 20 is attached to the main frame 2 by means of a wall brace clip 21. The brace 21 is formed in a manner similar to brace clip 3 and also comprises of two circular channels. These two channels, however run parallel to each other.

FIG. 10 shows another embodiment where the wall brace 22 is identical to wall brace 2 but the wall brace clip 23 is totally different. Wall brace clip 23 is designed to function using the principle of friction. Wall brace 22 is placed into one end of clip 23. The other end is pushed into the main frame 1.

FIG. 10 also shows another embodiment where the wall brace 24 is fashioned out of rectangular wire stock. The wall brace clip 25 is designed to only capture the main frame 1. Wall brace 24 is provided with an angular cut that enables it to brace alongside the main frame 1. A wing nut enables the wall brace clip 25 to tighten the assembly.

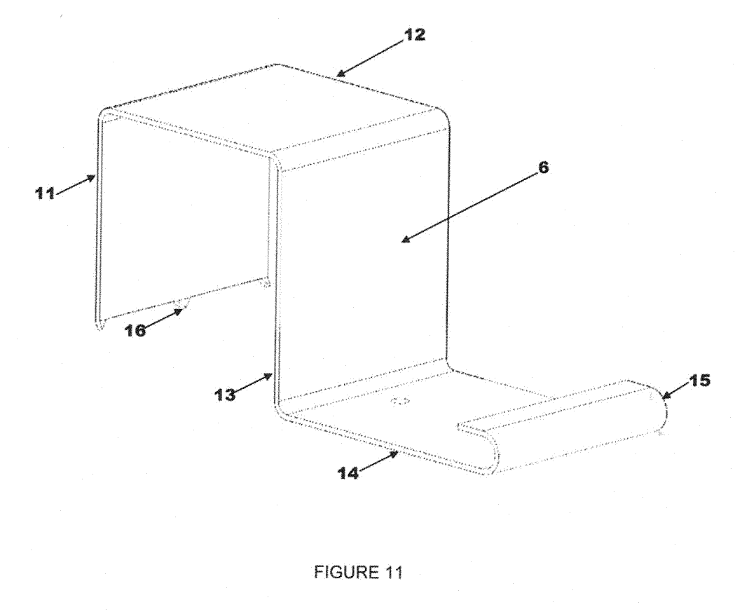

FIG. 11 shows one of the preferred embodiments of a sill clip 6 used for attaching the wire frame assembly to the window sill. The sill clip 6 is an important device that enables the pet perch to be located in a window 5 with or without the use of mechanical or adhesive devices such as screws, hook and loop fastening taps, suction cups, etc. Functionally, as shown in FIG. 11, the flap 11 is inserted between the window jamb and the window jamb and the window sill. The deployment of flap 11 works as a jam that inhibits the sill clip from moving up and down and stay firmly in place. The flap 11 is stamped so that one to ten teeth 16 can be incorporated during the production process. A preferred embodiment is to use three teeth so they can provide appropriate gripping in place. The horizontal brace 12 section enables the sill clip 13 to rest at the top of the sill. This inhibits the clip from moving in a tortuous radial movement and enhances stability. The vertical brace section 13 enables the sill clip 6 to sit on the sill while inhibiting any tortuous rotation. This vertical brace further enhances stability of the sill clip 6. The horizontal section 14 enables the sill clip to rest flat against the lower section of the sill, thus eliminating any further deflections and vibrations. Past the section 14, the sill clip 6 hooks back as exhibited as section 15. This wrap back enables the main frame wire 1 to snap into section 15.

FIG. 1 AND FIG. 2 shows that two sill clips 6 are necessary to hold the pet perch assembly safely against the window sill.

1-8. (canceled)

9. A window perch for cats, the window including a window frame and a window sash that is movable relative to the window frame, the window being positioned in a wall and spaced apart from a floor, the window perch comprising:
a frame including sides;
a stretchable, removable fabric cover supported by the frame;
at least one sill clip including a first end that is positionable between the window frame and the window sash and a second end that is coupled to the frame;
a wall brace that is attached to opposite sides of the frame; and
brace clips for attaching the wall brace to the frame, the wall brace being positionable against the wall and supporting the frame horizontally relative to the floor.

10. The window perch of claim 9 further comprising a cushioned pad coupled to the wall brace to prevent the wall brace from scratching the wall.

11. The window perch of claim 10, wherein the wall brace is movable relative to the frame to adjust the position of the frame relative to the wall.

12. The window perch of claim 9, wherein the frame is made of rigid wire ranging in diameter from ⅛″ to 1″, and the frame is machine bent into a rectangular configuration with rounded corners.

13. The window perch of claim 9, wherein the wall brace is made of rigid wire ranging in diameter from ⅛″ to 1″, and the wall brace is machine bent into a configuration with rounded corners.

14. The window perch of claim 9, wherein the brace clips include a die formed assembly having a first channel that is positioned horizontally relative to the floor and that receives the frame and a second channel that receives the wall brace and is positioned at an angle relative to the first channel, the angle ranging from 10° to 80°.

15. The window perch of claim 9, wherein each the brace clips includes a die formed assembly having a longitudinal component with side panels, a front tongue, and a rear tongue, wherein the frame and wall brace are secured to the longitudinal component by a screw, a wing nut and a lock washer.

16. The window perch of claim 9, wherein the at least one sill clip includes teeth.

17. The window perch of claim 9, wherein the at least one sill clip is coupled to the window sill without fasteners.

18. A window perch for cats, the window including a window frame and a window sash that is movable relative to the window frame, the window being positioned in a wall and spaced apart from a floor, the window perch comprising:
a frame including sides;
a stretchable, removable fabric cover supported by the frame;
at least one sill clip including a first end that is positionable between the window frame and the window sash and a second end that is coupled to the frame, the at least one sill clip including a body having a first end that is positionable between the window frame and the window sash, a second end opposite the first end that receives the frame in a snap fit engagement, and an intermediate portion extending between the first end and the second end, the intermediate portion configured to surmount the window frame such that the first end is positioned on one side of the window frame and the second end is positioned on an opposite side of the window frame;
a wall brace that is attached to opposite sides of the frame; and
brace clips for attaching the wall brace to the frame, the wall brace being positionable against the wall and supporting the frame horizontally relative to the floor.
